(19) United States
(12) Patent Application Publication
(10) Pub. No.: US 2017/0262855 A1
(43) Pub. Date: Sep. 14, 2017

(54) System and Method for Authentication and Payment in a Virtual Reality Environment

(71) Applicant: MASTERCARD ASIA/PACIFIC PTE LTD, Singapore (SG)

(72) Inventors: Vijin Venugopalan, Singapore (SG); Eric Jian Hui Lin, Singapore (SG); Benjamin Charles Gilbey, Singapore (SG)

(21) Appl. No.: 15/456,993

(22) Filed: Mar. 13, 2017

(30) Foreign Application Priority Data
Mar. 14, 2016 (SG) 10201601967U

(51) Int. Cl. G06Q 20/40; G06K 9/00; G06F 3/16; G06Q 20/36; G06F 3/01

(52) U.S. Cl. CPC G06Q 20/40145; G06Q 20/3674; G06F 3/017; G06F 3/167; G06F 3/011; G06K 9/00087; G06K 9/00617

(57) ABSTRACT

There is provided a system and method for authentication and payment when a user is immersed in a virtual reality environment when wearing a head-mountable virtual reality viewer. The authentication and payment can be carried out without a need for the user to remove the viewer.

### CROSS-REFERENCE TO RELATED APPLICATION

This application claims the benefit of and priority to Singapore Patent Application No. 10201601967U, filed Mar. 14, 2016. The entire disclosure of the above application is incorporated herein by reference.

### FIELD

Embodiments of the present disclosure relate to a system and method for authentication and payment in a virtual reality environment.

### BACKGROUND

This section provides background information related to the present disclosure which is not necessarily prior art.

Virtual reality headsets are becoming increasingly prevalent, with headsets being manufactured by, typically, consumer electronics manufacturers, software manufacturers, and digital devices manufacturers, and the like. The ready availability and lowering of prices of the headsets has led to an increasing number of headsets being purchased by consumers.

Generally, the premise of virtual reality headsets relates to immersion of consumers into a virtual environment, but an extent of interactivity between the consumers and the virtual environment is limited. Typically, at least one handheld controller may be used or optical sensors (gesture detection) may be used to enable interactivity between the consumers and the virtual environment.

Currently, virtual reality is primarily used for entertainment, and the consumer is not able to carry out much more than tasks other than pertaining to entertainment.

### SUMMARY

This section provides a general summary of the disclosure, and is not a comprehensive disclosure of its full scope or all of its features. Aspects and embodiments of the disclosure are also set out in the accompanying claims.

There is provided a system for authentication and payment in a virtual reality environment. The system comprises a virtual reality viewer; a biometric sensor communicatively coupled to or integrated with the viewer; and a data storage communicatively coupled to or integrated with the viewer, the data storage having stored thereon digital wallet data relating to a user's digital wallet, the digital wallet being associated with an identification parameter of the user. It is advantageous that authentication of the user via the biometric sensor enables use of the associated digital wallet during use of the viewer.

The system can further comprise at least one controller communicatively coupled to the viewer, the at least one controller being configured to be usable during use of the viewer, at least one gesture sensor communicatively coupled to the viewer, the at least one gesture sensor being configured to detect gestures of the user, and/or at least one microphone communicatively coupled to the viewer, the at least one microphone being configured to detect a voice command from the user.

Preferably, the virtual reality viewer is head-mountable. The biometric sensor can be configured to carry out an iris scan or a fingerprint scan.

The system can further comprise a server communicatively coupled to the viewer for storing biometric data of a plurality of users. It is preferable that the user is authenticated when captured data at the biometric sensor matches associated stored biometric data at the server.

It is preferable that the data storage is communicatively coupled to the viewer either via a physical wired connection or via a wireless paired connection.

Preferably, the digital wallet data includes an identification parameter, the identification parameter being at least one identifier, such as, for example, user name, user ID number, user account number, user email address, user contact number, and so forth.

There is also provided a second system for authentication and payment in a virtual reality environment. The system comprises a virtual reality viewer; a mobile device being coupled to the viewer for viewing content via the viewer; a biometric sensor communicatively coupled to or integrated with the mobile device; and a data storage communicatively coupled to or integrated with the mobile device, the data storage having stored thereon digital wallet data relating to a user's digital wallet, the digital wallet being associated with an identification parameter of the user. Advantageously, authentication of the user via the biometric sensor enables use of the associated digital wallet during use of the viewer. Preferably, the virtual reality viewer is head-mountable.

The system can further comprise at least one controller communicatively coupled to the mobile device, the at least one controller being usable during use of the viewer, and/or at least one gesture sensor communicatively coupled to the mobile device, the at least one gesture sensor being configured to detect gestures of the user.

Preferably, the biometric sensor is configured to either carry out an iris scan or carry out a fingerprint scan.

The system can further comprise a server communicatively coupled to the mobile device for storing biometric data of a plurality of users. It is preferable that the user is authenticated when captured data at the biometric sensor matches associated stored biometric data at the server.

It is preferable that the data storage is communicatively coupled to the mobile device via either a physical wired connection or a wireless paired connection.

Preferably, the digital wallet data includes an identification parameter, the identification parameter being at least one identifier, such as, for example, user name, user ID number, user account number, user email address, user contact number, and so forth.

In another aspect, there is provided a data processor implemented method for authentication and payment in a virtual reality environment. The method comprises pairing a digital wallet associated with an identification parameter of a user with a virtual reality viewer, the digital wallet being stored on a data storage communicatively coupled to or integrated with the viewer, the data storage having stored thereon digital wallet data relating to the user's digital wallet; authenticating the user via a biometric sensor; and receiving instructions from the user immersed in the virtual reality environment, the instructions being for carrying out transactions in the virtual reality environment using the associated digital wallet. Preferably, the authentication of the user via the biometric sensor enables use of the associated digital wallet.

It is preferable that the digital wallet data includes an identification parameter, the identification parameter being at least one identifier, such as, for example, user name, user ID number, user account number, user email address, user contact number, and so forth.

Preferably, the biometric sensor is configured to either carry out an iris scan or a fingerprint scan.

The instructions can preferably include information, such as, for example, product ID, service ID, merchant ID, payment quantum, delivery address, and so forth.

Preferably, the instructions are provided by the user using at least one controller, using voice commands and/or using gestures.

The user is preferably authenticated when captured data at the biometric sensor matches associated stored biometric data at a server.

In a further aspect, there is provided a data processor implemented method for authentication and payment in a virtual reality environment. The method comprises authenticating a user via a biometric sensor; and receiving instructions from the user immersed in the virtual reality environment, the instructions being for carrying out transactions in the virtual reality environment using an associated digital wallet, the digital wallet being associated with an identification parameter of the user. It is advantageous that the authentication of the user via the biometric sensor enables use of the associated digital wallet.

Preferably, the digital wallet is stored on a data storage device communicatively coupled to a mobile device, the data storage having stored thereon digital wallet data relating to the user's digital wallet. The digital wallet data can include an identification parameter, the identification parameter being at least one identifier, such as, for example, user name, user ID number, user account number, user email address, user contact number, and the like.

It is preferable that the biometric sensor is configured to either carry out an iris scan or a fingerprint scan.

The instructions can preferably include information, such as, for example, product ID, service ID, merchant ID, payment quantum, delivery address, and so forth. The instructions can be provided by the user using at least one controller, using voice commands and/or using gestures.

The user is preferably authenticated when captured data at the biometric sensor matches associated stored biometric data at a server.

There is also provided a non-transitory computer readable storage medium embodying thereon a program of computer readable instructions which, when executed by one or more processors of a virtual reality viewer in communication with at least one server, cause the at least one server to perform a method for authentication and payment in a virtual reality environment. The method being embodied in the steps of pairing a digital wallet associated with an identification parameter of a user with the virtual reality viewer, the digital wallet being stored on a data storage communicatively coupled to or integrated with the viewer, the data storage having stored thereon digital wallet data relating to the user's digital wallet; authenticating the user via a biometric sensor; and receiving instructions from the user immersed in the virtual reality environment, the instructions being for carrying out transactions in the virtual reality environment using the associated digital wallet. It is preferable that the authentication of the user via the biometric sensor enables use of the associated digital wallet.

The digital data preferably includes an identification parameter, the identification parameter being at least one identifier, such as, for example, user name, user ID number, user account number, user email address, user contact number, and so forth.

The biometric sensor can be configured to carry out either an iris scan or a fingerprint scan.

The instructions can include information such as, for example, product ID, service ID, merchant ID, payment quantum, delivery address and so forth.

The instructions can be provided by the user using at least one controller, using voice commands, and/or using gestures.

It is preferable that the user is authenticated when captured data at the biometric sensor matches associated stored biometric data at an authentication server.

In a final aspect, there is a non-transitory computer readable storage medium embodying thereon a program of computer readable instructions which, when executed by one or more processors of a mobile device coupled to a virtual reality viewer for viewing content via the viewer, in communication with at least one server, cause the at least one server to perform a method for authentication and payment in a virtual reality environment. The method being embodied in the steps of authenticating a user via a biometric sensor; and receiving instructions from the user immersed in the virtual reality environment, the instructions being for carrying out transactions in the virtual reality environment using an associated digital wallet, the digital wallet being associated with an identification parameter of the user. It is advantageous that the authentication of the user via the biometric sensor enables use of the associated digital wallet.

The digital wallet is preferably stored on a data storage device communicatively coupled to the mobile device, the data storage having stored thereon digital wallet data relating to the user's digital wallet.

The digital wallet data can preferably include an identification parameter, the identification parameter being at least one identifier, such as, for example, user name, user ID number, user account number, user email address, user contact number, and the like.

Preferably, the biometric sensor is configured to carry out either an iris scan or a fingerprint scan.

The instructions can include information selected from, for example, product ID, service ID, merchant ID, payment quantum, delivery address, and so forth.

The instructions can be provided by the user using at least one controller, using voice commands and/or using gestures.

It is preferable that the user is authenticated when captured data at the biometric sensor matches associated stored biometric data at an authentication server.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, in order that the present disclosure may be fully understood and readily put into practical effect, there shall now be described by way of non-limitative example only, certain embodiments of the present disclosure, the description being with reference to the accompanying illustrative figures, in which:

FIG. 1 shows a schematic overview of a first system according to certain embodiments of the present disclosure.

FIG. 2 shows a schematic overview of a second system according to certain embodiments of the present disclosure.

FIG. 3 shows a process flow of a method according to certain embodiments of the present disclosure.

FIG. 4 shows a schematic view of a mobile device used in the second system shown in FIG. 2.

FIG. 5 shows a schematic view of a server used in the systems and method.

### DETAILED DESCRIPTION

Embodiments of the present disclosure will be described, by way of example only, with reference to the drawings. The description and specific examples included herein are intended for purposes of illustration only and are not intended to limit the scope of the present disclosure. Like reference numerals and characters in the drawings refer to like elements or equivalents.

The present disclosure is able to enable authentication of a user immersed in a virtual reality experience, and consequently, the user is able to make payments when immersed in the virtual reality experience. This makes commerce such as, for example, purchase of objects, purchase of services, and so forth, possible within the context of a virtual reality experience.

Some constituent components which are referred to in the detailed description will be described first.

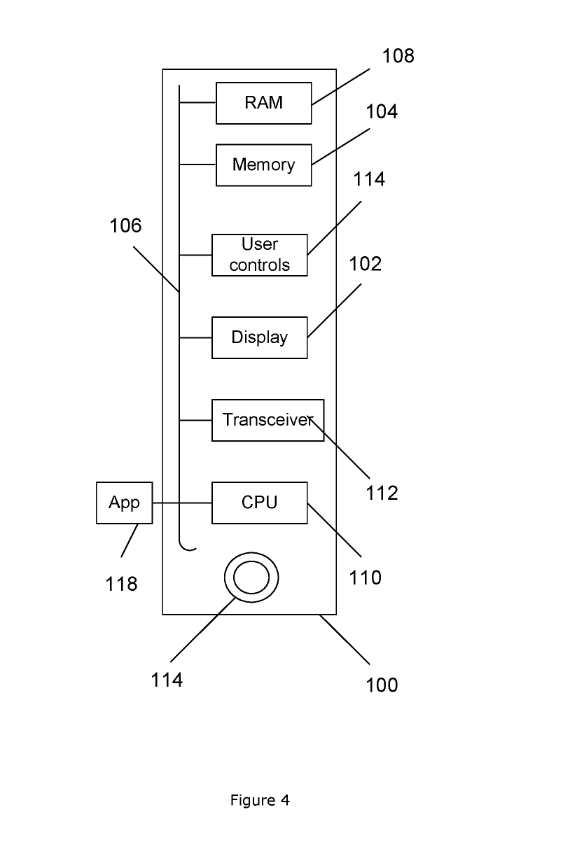

Referring to FIG. 2, there is shown use of a mobile device 100. The mobile device 100 is a handheld device, such as a smartphone or a tablet computer, such as one manufactured by Apple™, LG™, HTC™, Samsung™, and Motorola™. An exemplary embodiment of the mobile device 100 is shown in FIG. 4. As shown, the device 100 includes the following components in electronic communication via a bus 106:
a display 102;
non-volatile memory 104;
random access memory (“RAM”) 108;
N processing components 110;
a transceiver component 112 that includes N transceivers;
user controls 114; and
an app 118.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 102 generally operates to provide a presentation of content to a user, and may be realized by any of a variety of displays (e.g., CRT, LCD, HDMI, micro-projector and OLED displays). And in general, the non-volatile memory 104 functions to store (e.g. persistently store) data and executable code including code that is associated with the functional components of the method. In some embodiments, for example, the non-volatile memory 104 includes bootloader code, modem software, operating system code, file system code, and code (for example, an app 118) to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

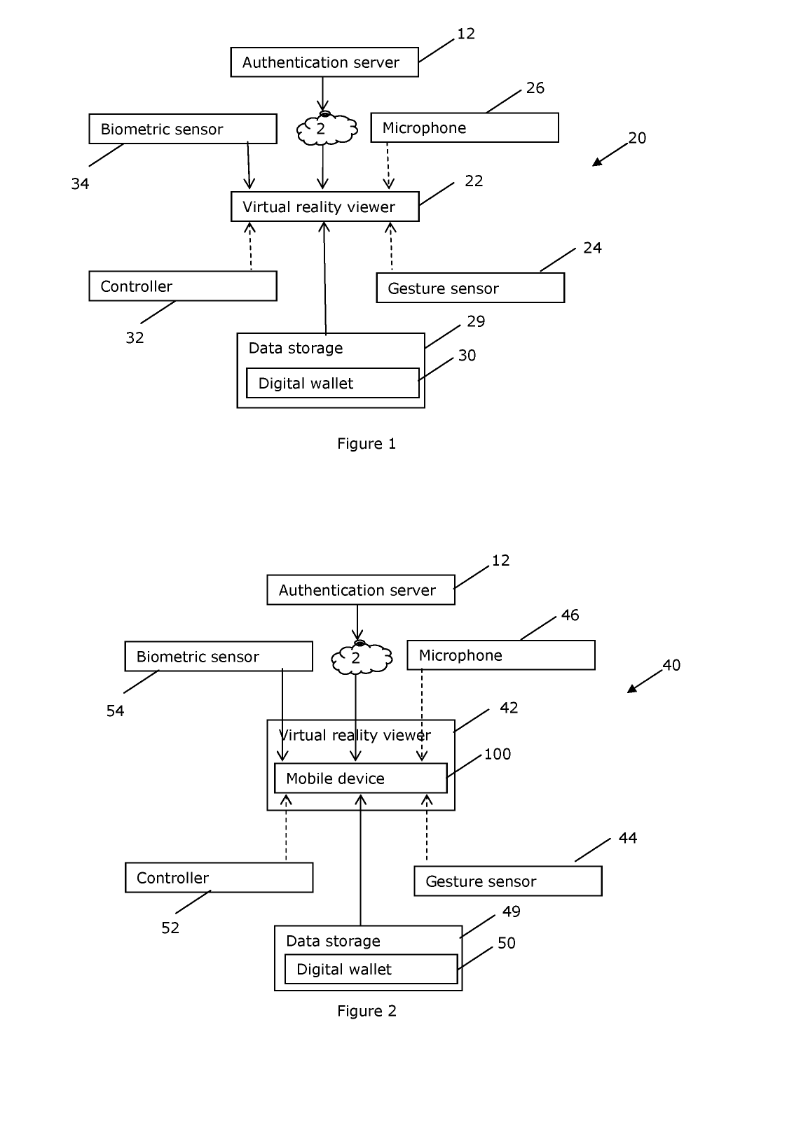

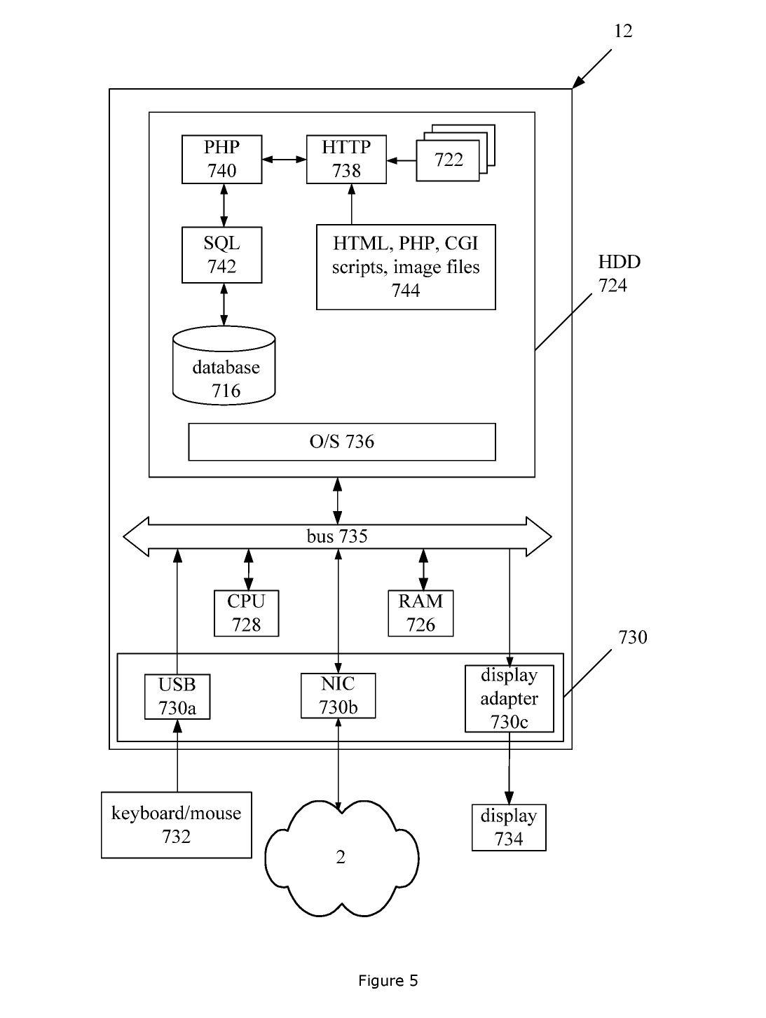

Referring to FIGS. 1 and 2, there is shown use of authentication server 12, with a more detailed view of the authentication server 12 being shown in FIG. 5. The server 12 is able to communicate with the mobile device 100 over a communications network 2 using standard communication protocols.

Processes carried out by the server 12 can be performed in a variety of ways. The processes can be implemented entirely by software to be executed on computer server hardware, which may comprise one hardware unit or different computer hardware units distributed over various locations, some of which may require the communications network 2 for communication. A number of the components or parts thereof may also be implemented by application specific integrated circuits (ASICs) or field programmable gate arrays.

In FIG. 5, the server 12 is a commercially available server computer system based on a 32 bit or a 64 bit Intel architecture, and the processes and/or methods executed or performed by the computer server 12 are implemented in the form of programming instructions of one or more software components or modules 722 stored on non-volatile (e.g., hard disk) computer-readable storage 724 associated with the server 12. At least parts of the software modules 722 could alternatively be implemented as one or more dedicated hardware components, such as application-specific integrated circuits (ASICs) and/or field programmable gate arrays (FPGAs).

The server 12 includes at least one or more of the following standard, commercially available, computer components, all interconnected by a bus 735:
1. random access memory (RAM) 726;
2. at least one computer processor 728, and
3. external computer interfaces 730:
   a. universal serial bus (USB) interfaces 730a (at least one of which is connected to one or more user-interface devices, such as a keyboard, a pointing device (e.g., a mouse 732 or touchpad),
   b. a network interface connector (NIC) 730b which connects the server 12 to a data communications network, such as the Internet 2; and
   c. a display adapter 730c, which is connected to a display device 734 such as a liquid-crystal display (LCD) panel device.

The server 12 includes a plurality of standard software modules, including:
1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 12 with the general ability to allow users of the Internet 2 with mobile device 100 equipped with standard web browser software to access the server 12 and in particular to provide data to and receive data from the database 716. It will be understood by those skilled in the art that the specific functionality provided by the server 12 to such users is provided by scripts accessible by the web server 738, including the one or more software modules 722 implementing the processes performed by the server 12, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 12 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions, such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Referring to FIG. 1, there is provided a system 20 for authentication and payment in a virtual reality environment. The system 20 comprises a virtual reality viewer 22, the viewer 22 being head-mountable. In some embodiments, the viewer 22 includes a microprocessor to process data to enable a user to be immersed in a virtual reality experience and for other functions.

The system 20 can include a biometric sensor 34 communicatively coupled to the viewer 22. The biometric sensor 34 can be configured to carry out an iris scan or a fingerprint scan. It should be appreciated that the biometric sensor 34 is configured to carry out an iris scan while the viewer 22 is worn by the user. This ensures that carrying out an iris scan for the user is convenient in the course of using the viewer 22. Only a single biometric sensor 34 is shown, but in practice it would be possible to have multiple biometric sensors, for example, multiple iris scanners and/or fingerprint sensors.

In addition, the system 20 includes a data storage 29 communicatively coupled to or integrated with the viewer 22, the data storage 29 having stored thereon digital wallet data relating to the user's digital wallet 30, the digital wallet 30 being associated with an identification parameter of the user. The data storage 29 is communicatively coupled to the viewer 22, either via a physical wired connection or via a wireless paired connection. The digital wallet data can include an identification parameter, the identification parameter being at least one identifier, such as, for example, user name, user ID number, user account number, user email address, user contact number and the like.

The system 20 can also further comprise at least one of: at least one controller 32 communicatively coupled to the viewer 22, at least one gesture sensor 24 communicatively coupled to the viewer 22, or at least one microphone 26 communicatively coupled to the viewer 22, whereby each of the at least one controller 32, the at least one gesture sensor 24, and the at least one microphone 26 enables the user to carry out tasks when immersed in the virtual reality environment during use of the viewer 22. For example, the at least one controller 32 can include control activators triggered by the user, the at least one gesture sensor 24 can detect motion of the user's appendage(s), the at least one microphone 26 can detect a voice command from the user, and so forth.

The system 20 can also comprise an authentication server 12 communicatively coupled to the viewer 22 for storing biometric data of a plurality of users. In some embodiments, the authentication server 12 is configured to communicate with the viewer 22 via a network interface(s) over communications network 2, whereby communications over the communications network 2 enables authentication of the user to be carried out subsequent to completing a payment process. It should be appreciated that the payment process can be carried out by the authentication server 12 or another server(s) after the user is authenticated.

Typically, the digital wallet 30 generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP) or the merchant's acquirer in a known manner. It is appreciated that suitable known methods of conducting secure electronic commerce transactions can be employed.

In the system 20, authentication of the user via the biometric sensor 34 enables use of the associated digital wallet 30 in the manner described earlier during use of the viewer 22, whereby the user is authenticated when captured data at the biometric sensor 34 matches associated stored biometric data at the server 12.

Referring to FIG. 2, there is provided another system 40 for authentication and payment in a virtual reality environment. A difference of the system 40 and the afore-described system 20 relates to a viewer 42 used in the system 40. The viewer 42 used in the system 40 may have reduced or no data processing capability, such that computing-intensive operations, such as data processing and virtual reality content, are delegated to a mobile device 100 (as described earlier) mounted an/or coupled to the viewer 42, for example, via a physical wired connection or via a wireless pairing (for example, using a WiFi or Bluetooth connection). Typically, the virtual reality content is shown on the display 102 of the mobile device 100 and the mobile device 100 is mounted to the viewer 42 in a manner where the user wearing the viewer 42 is able to be immersed in the virtual reality environment. It should be appreciated that the mobile device 100 is also able to enable the user to carry out other functions. In other embodiments, the mobile device 100 may be replaced by an alternative computing device, such as a desktop or laptop computing system.

The system 40 can include a biometric sensor 54 communicatively coupled to or integrated with the mobile device 100. The biometric sensor 54 can be configured to carry out an iris scan or a fingerprint scan. It should be appreciated that the biometric sensor 54 is configured to carry out an iris scan while the viewer 42 is worn by the user. This ensures that carrying out an iris scan for the user is convenient in the course of using the viewer 42. As in the system 20, there may be multiple biometric sensors 54.

In addition, the system 40 includes a data storage 49 communicatively coupled to or integrated with the mobile device 100, the data storage 49 having stored thereon digital wallet data relating to the user's digital wallet 50, the digital wallet 50 being associated with an identification parameter of the user. The data storage 49 is communicatively coupled to the mobile device 100 either via a physical wired connection or via a wireless paired connection. The digital wallet data can include an identification parameter, the identification parameter being at least one identifier, such as, for example, user name, user ID number, user account number, user email address, user contact number, and the like.

The system 40 can also further comprise at least one of: at least one controller 52 communicatively coupled to the mobile device 100, at least one gesture sensor 44 communicatively coupled to the mobile device 100, or at least one microphone 46 communicatively coupled to the viewer 42, whereby each of the at least one controller 52, the at least one gesture sensor 44, and the at least one microphone 46 enables the user to carry out tasks when immersed in the virtual reality environment during use of the viewer 22. For example, the at least one controller 52 can include control activators triggered by the user, the at least one gesture sensor 44 can detect motion of the user's appendage(s), the at least one microphone 46 can detect a voice command from the user, and so forth.

The system 40 can also comprise the authentication server 12 communicatively coupled to the mobile device 100 for storing biometric data of a plurality of users. In some embodiments, the authentication server 12 is configured to communicate with the mobile device 100 via a network interface(s) over the communications network 2, whereby communications over the communications network 2 enables authentication of the user to be carried out subsequent to completing a payment process. It should be appreciated that the payment process can be carried out by the authentication server 12 or another server(s) after the user is authenticated.

Typically, the digital wallet 50 generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP) or the merchant's acquirer in a known manner. It is appreciated that suitable known methods of conducting secure electronic commerce transactions can be employed.

In the system 40, authentication of the user via the biometric sensor 54 enables use of the associated digital wallet 50 in the manner described earlier during use of the viewer 42, whereby the user is authenticated when captured data at the biometric sensor 54 matches associated stored biometric data at the server 12.

In either the system 20 or the system 40, the data storage 29/49 may be integrated into the viewer 22/42, or in the case of system 40, may be part of the mobile device 100. Similarly, the biometric sensors 34/54 may be separate components which are coupled to the viewer 22/42, or are integrated with the viewer 22/42 or with the mobile device 100. For example, in system 40, the viewer 42 may have essentially no processing power, but may simply act as a frame or support to mount the mobile device 100 (optionally providing power via a docking interface of the mobile device 100) such that the viewer 42 can be worn by a user with the mobile device 100 mounted in the user's field of view. It should be noted, for example, that a camera integrated with the mobile device 100 (not shown in FIG. 4) can be used as a biometric sensor (iris scanner) during instances when the camera is able to capture a requisite image detail for the assessment of irises using requisite software.

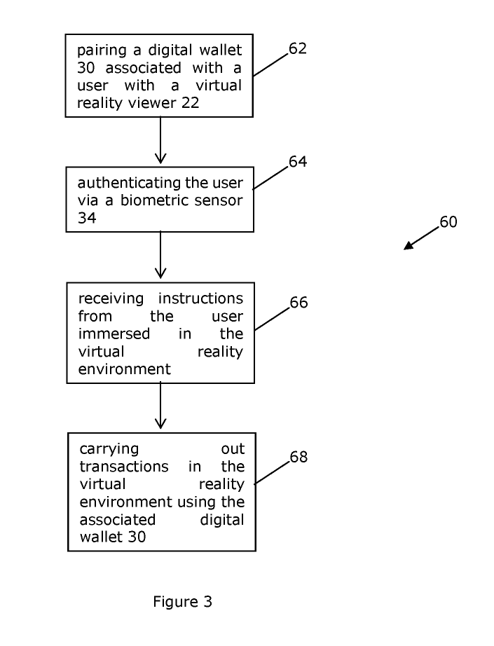

With reference to FIG. 3, there is provided a data processor implemented method 60 for authentication and payment in a virtual reality environment. The method 60 is typically carried out using a virtual reality viewer which includes a microprocessor and is configured to process data to enable a user to be immersed in a virtual reality experience and for other functions. For the sake of clarity, labelling of components used in FIG. 1 will be re-used in FIG. 3.

The method 60 includes pairing a digital wallet 30 associated with an identification parameter of a user with a virtual reality viewer 22 (62). The digital wallet 30 can be stored on a data storage 29 communicatively coupled to or integrated with the viewer 22, the data storage 29 having stored thereon digital wallet data relating to the user's digital wallet 30. The digital wallet data can include as identification parameter, the identification parameter being at least one identifier, such as, for example, user name, user ID number, user account number, user email address, user contact number, and the like. The pairing can be carried out, for example, by the user granting access to the digital wallet 30 via the virtual reality viewer 22, where the digital wallet 30 is accessible on a mobile device. Then, there is authentication of the user via a biometric sensor 34 (64). The biometric sensor 34 can be configured to carry out an iris scan or a fingerprint scan. It should be appreciated that the biometric sensor 34 is configured to carry out an iris scan while the viewer 22 is worn by the user. This ensures that carrying out an iris scan for the user is convenient in the course of using the viewer 22. The user is authenticated when captured data at the biometric sensor 34 matches associated stored biometric data at an authentication server 12. In some embodiments, the authentication server 12 is configured to communicate with the viewer 22 via a network interface(s) over communications network 2, whereby communications over the communications network 2 enables authentication of the user to be carried out subsequent to completing a payment process. It should be appreciated that the payment process can be carried out by the authentication server 12 or another server(s) after the user is authenticated.

The method 60 can also include receiving instructions from the user immersed in the virtual reality environment (66), where the instructions are for carrying out transactions in the virtual reality environment using the associated digital wallet 30 (68). The instructions can include information, such as, for example, product ID, service ID, merchant ID, payment quantum, delivery address, and so forth. The instructions can be provided by the user using, for example, at least one controller 32, voice commands, gestures from an appendage(s), and so forth.

In the method 60, the authentication of the user via the biometric sensor 34 enables use of the associated digital wallet 30. Typically, the digital wallet 30 generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP) or the merchant's acquirer in a known manner. It is appreciated that suitable known methods of conducting secure electronic commerce transactions can be employed.

It should be appreciated that when the virtual reality viewer is similar to the viewer 42, the method 60 would be similar except that there would be no necessity to pair the digital wallet with the mobile device 100, since the digital wallet is already paired with the mobile device 100.

In the preceding description, it should be noted that the types of virtual experiences can relate to either dedicated shopping virtual reality environments or entertainment content with in-content product placement.

In view of the preceding description, the systems 20, 40 and method 60 are respectively able to enable authentication of a user immersed in a virtual reality experience, and consequently, enables the user to be able to make payments when immersed in the virtual reality experience. In such an instance, the user need not leave the virtual reality experience in order to make purchases. This avoids discomfort to the user when the user wishes to access payment facilities and having to adjust to lighting conditions upon removal of the virtual reality viewer. In addition, the convenience of the user in making purchases in the virtual reality environment is also enhanced without having to remove the virtual reality viewer in order to make payment.

Whilst there have been described in the foregoing description preferred embodiments of the present disclosure, it will be understood by those skilled in the technology concerned that many variations or modifications in details of design or construction may be made without departing from the present disclosure.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for authentication and payment in a virtual reality environment, the system comprising:
a virtual reality viewer;
a biometric sensor communicatively coupled to or integrated with the viewer; and
a data storage communicatively coupled to or integrated with the viewer, the data storage having stored thereon digital wallet data relating to a user's digital wallet, the digital wallet being associated with an identification parameter of the user;
wherein authentication of the user via the biometric sensor enables use of the associated digital wallet during use of the viewer.

2. The system of claim 1, further comprising:
at least one controller communicatively coupled to the viewer, the at least one controller being configured to be usable during use of the viewers;
at least one gesture sensor communicatively coupled to the viewer, the at least one gesture sensor being configured to detect gestures of the user; and/or
at least one microphone communicatively coupled to the viewer, the at least one microphone being configured to detect a voice command from the user.

3.-5. (canceled)

6. The system of claim 1, wherein the biometric sensor is configured to carry out either an iris scan or a fingerprint scan.

7. (canceled)

8. The system of claim 6, further comprising a server communicatively coupled to the viewer for storing biometric data of a plurality of users;
wherein the user is authenticated when captured data at the biometric sensor matches associated stored biometric data at the server.

9. (canceled)

10. The system of claim 1, wherein the data storage is communicatively coupled to the viewer via either a physical wired connection or a wireless paired connection.

11. (canceled)

12. The system of claim 1, wherein the digital wallet data includes the identification parameter, the identification parameter being at least one identifier selected from a group consisting of: user name, user ID number, user account number, user email address, and user contact number.

13. A system for authentication and payment in a virtual reality environment, the system comprising:
a virtual reality viewer;
a mobile device being coupled to the viewer for viewing content via the viewer;
a biometric sensor communicatively coupled to or integrated with the mobile device; and
a data storage communicatively coupled to or integrated with the mobile device, the data storage having stored thereon digital wallet data relating to a user's digital wallet, the digital wallet being associated with an identification parameter of the user;
wherein authentication of the user via the biometric sensor enables use of the associated digital wallet during use of the viewer.

14. The system of claim 13, further comprising:
at least one controller communicatively coupled to the mobile device, the at least one controller being usable during use of the viewer; and/or
at least one gesture sensor communicatively coupled to the mobile device, the at least one gesture sensor being configured to detect gestures of the user.

15.-16. (canceled)

17. The system of claim 13, wherein the biometric sensor is configured to carry out either an iris scan or a fingerprint scan.

18. (canceled)

19. The system of claim 17, further comprising a server communicatively coupled to the mobile device for storing biometric data of a plurality of users;
wherein the user is authenticated when captured data at the biometric sensor matches associated stored biometric data at the server.

20. (canceled)

21. The system of claim 13, wherein the data storage is communicatively coupled to the mobile device via either a physical wired connection or a wireless paired connection.

22. (canceled)

23. The system of claim 13, wherein the digital wallet data includes the identification parameter, the identification parameter being at least one identifier selected from a group consisting of: user name, user ID number, user account number, user email address, and user contact number.

24.-32. (canceled)

33. A data processor implemented method for authentication and payment in a virtual reality environment, the method comprising:
authenticating a user via a biometric sensor; and
receiving, by a processor, instructions from the user immersed in the virtual reality environment, the instructions being for carrying out transactions in the virtual reality environment using an associated digital wallet, the digital wallet being associated with an identification parameter of the user;
wherein the authentication of the user via the biometric sensor enables use of the associated digital wallet.

34. The method of claim 33, wherein the digital wallet is stored on a data storage device communicatively coupled to a mobile device, the data storage having stored thereon digital wallet data relating to the user's digital wallet; and
wherein the digital wallet data includes the identification parameter, the identification parameter being at least one identifier selected from a group consisting of: user name, user ID number, user account number, user email address, and user contact number.

35. (canceled)

36. The method of claim 33, wherein the biometric sensor is configured to carry out either an iris scan or a fingerprint scan.

37. (canceled)

38. The method of claim 33, wherein the instructions include information selected from a group consisting of: product ID, service ID, merchant ID, payment quantum, and delivery address.

39. The method of claim 33, wherein the instructions are provided by the user using at least one controller, using voice commands, and/or using gestures.

40.-41. (canceled)

42. The method of claim 33, wherein the user is authenticated when captured data at the biometric sensor matches associated stored biometric data at a server.

43.-61. (canceled)

62. The method of claim 33, further comprising pairing, by the processor, the digital wallet with a virtual reality viewer, the digital wallet being stored on a data storage communicatively coupled to or integrated with the viewer, the data storage having stored thereon digital wallet data relating to the user's digital wallet.

63. The method of claim 62, wherein the digital wallet data includes the identification parameter, the identification parameter being at least one identifier selected from a group consisting of: user name, user ID number, user account number, user email address, and user contact number.
